(19) United States
(12) Patent Application Publication
(10) Pub. No.: US 2011/0060720 A1
(43) Pub. Date: Mar. 10, 2011

(54) VIRTUAL MANAGEMENT SYSTEM AND METHOD

(76) Inventor: Steven Michael Devereux, Beuste (FR)

(21) Appl. No.: 12/878,976

(22) Filed: Sep. 9, 2010

(30) Foreign Application Priority Data
Sep. 10, 2009 (GB) 0915863.5

(51) Int. Cl. G06F 17/30

(52) U.S. Cl. 707/610; 707/E17.005

(57) ABSTRACT

A virtual management system for completing a project, wherein the project includes a function having one or more tasks associated therewith, the system comprising: a database object (VC) for the function, wherein the database object includes a pair of database object parts (Struc and Mat); wherein a first part of the pair of database object parts relate to a structure for the or each task and a second part of the pair of database object parts relate to a content element for the or each task; and wherein the first part undergoes an evolution in response to user input to enable improvements to be implemented for a particular function, such that the evolution applies to the particular function in any project managed by the virtual management system; and further wherein the second part can be replicated for a subsequent function to generate a subsequent database object for the subsequent function.

### PRIORITY CLAIM

This application claims the benefit of United Kingdom patent application no. 0915863.5 filed Sep. 10, 2009, the disclosure of which is incorporated herein by reference in its entirety.

### FIELD OF THE INVENTION

The present invention relates to a virtual management system and method, particularly but not exclusively in respect of evolving and replicating databases.

### BACKGROUND OF THE INVENTION

Virtual systems to manage various processes online already exist. In each case, the system must be designed and created “ready to use” with all the essential tasks and relationships defined. This means that the current systems require upfront investment of time and effort to define the tasks and relationships before the system can be used. Subsequent changes and improvements often force a redesign of the system.

### OBJECTS OF THE INVENTION

It is an object of the present invention to overcome at least some of the problems associated with the prior art.

It is an object of the present invention to overcome one significant difficulty inherent in the prior art; that is that a new project requires somebody to define the essential tasks and task relationships before the system can be used.

It is a further object of the present invention to provide a virtual management system that is capable of evolving and replicating through many layers of processes.

### SUMMARY OF THE INVENTION

The present invention provides a method and system as set out in the accompanying claims.

According to one aspect of the present invention there is provided a virtual management system for completing a project, wherein the project includes a function having one or more tasks associated therewith, the system comprising: a database object (VC) for the function, wherein the database object includes a pair of database object parts (Struc and Mat); wherein a first part of the pair of database object parts relate to a structure for the or each task and a second part of the pair of database object parts relate to a content element for the or each task; and wherein the first part undergoes an evolution in response to user input to enable improvements to be implemented for a particular function, such that the evolution applies to the particular function in any project managed by the virtual management system; and further wherein the second part can be replicated for a subsequent function to generate a subsequent database object for the subsequent function.

One key benefit to the present invention is that the project management system can be used for a new project without prior definitions of tasks and relationships as it develops as it is used, with each user participating in it's development. Another key benefit is that learning from previous experience can be incorporated into the management system in such a way that it is of benefit to all other users, allowing rapid development of the management system for a new project.

### BRIEF DESCRIPTION OF THE DRAWINGS

Reference will now be made, by way of example, to the accompanying drawings, in which:

FIG. 1 is a diagram of a virtual cell structure showing certain essential fields, in accordance with an embodiment of the invention,

FIG. 2 is a diagram of an example of a virtual cell structure for a, particular application, in accordance with an embodiment of the invention,

FIG. 3 is a diagram of any virtual cell template for the full structure of a virtual management system, in accordance with an embodiment of the invention,

FIG. 4 is a diagram of a possible graphic view of a project within a virtual management system website, in accordance with an embodiment of the invention.

### DETAILED DESCRIPTION OF THE PREFERRED EMBODIMENTS

A virtual management system may take many different forms and include many different databases and processes. The present invention takes a different approach to a virtual management system by developing a very simple Virtual Cell which can be developed and grown to produce the various different fields of the database or the processes associated with the virtual management system. The virtual cell is a database object and is to some extent analogous to a biological cell used to build a simple organism. As evolution occurs the cell can become fitter and more capable and perhaps adapted to a particular purpose. The cell can also replicate creating new copies as required. Evolving and replicating in this way allows a complex organism to be grown starting with a very simple single cell. The present invention works in a similar way but in a virtual management system using a database object in the form of an initial simple virtual cell (VC). This is a simple cell which can evolve over time into more complex structures. The VC evolves by becoming more capable and useful for the intended purpose. Unlike a biological cell, when the VC evolves, all copies of that type of VC also evolve, even those that are already part of a structure.

Different types of VC can be created (just as a stem Cell can evolve into any other kind of cell) and those different VC types can also evolve and replicate. Each type of VC has a unique name and a unique identifying code defined at creation of the cell. By designing a VC that is capable of evolving, replicating and creating different types, a structure of high complexity can be built over time, without the need to define every parameter from the start.

A structure of a VC can be replicated so that creating a new structure can be based on an existing structure, (or a part thereof) or different parts of different structures. Therefore a complex new structure that has aspects and parameters similar to an existing structure can be easily and quickly created. The evolving VC can be used to set up a database-based Virtual Management System to manage projects of high complexity, which learns lessons from existing aspects, parameters and projects to apply those to future projects.

The initial VC consists of a pair of database objects. One part of the pair in the example here is called “Struc” and the other part is called “Mat”. These parts can be considered to define the structure of the VC (Struc) and the material it contains (Mat). Each VC is actually a set of tasks or instructions required to carry out a particular project or the functions of a project. If the project includes only one VC the project and the function are essentially the same. If the project includes multiple VCs the functions will be different to the project and will constitute the functions required to complete the project. This can be more fully understood by using an example VC that contains instructions to “Frame a picture”.

While the first VC of any particular type starts of as a pair, each time that type of VC replicates, only a new Mat part is created. After a time, a VC of type “Frame a picture” will consist of one “Struc” part and many “Mat” parts. Thus replication only involves the Mat part of the VC.

When an improvement is identified to the “Frame a picture” VC, the Struc part is modified to reflect that improvement. A user having the required privileges can modify the Struc. When the Struc is changed, all existing “Frame a picture” VCs are also changed. Thus evolution only involves the Struc part of the VC.

Within the Virtual Management System, a user working with a particular VC can see both the Struc and Mat. The user can work with and update both the Struc and the Mat. Fields modified within the Struc are visible to all “Frame a picture” VCs in the system. As a consequence, the change is then visible to every VC of this type. Some changes to the Struc may require a user to have administrative privileges and this may be specified within the database.

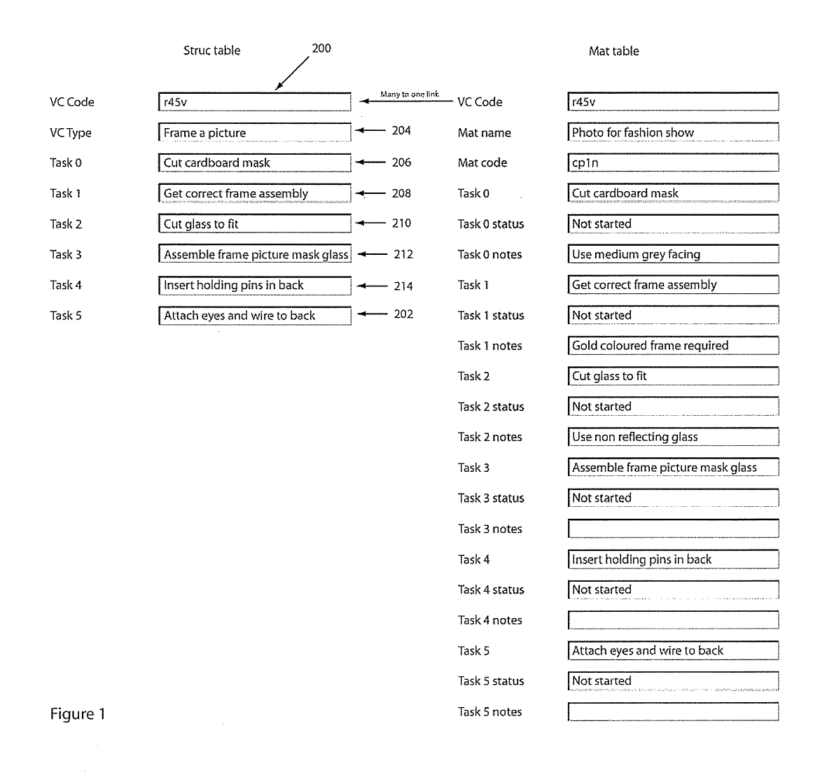

Referring to FIG. 1, the minimum fields necessary within the Struc and the Mat tables are defined.

The Struc database object 10 contains as a minimum the following fields or objects.

A VC Type 100 in the form of a unique alphanumeric name, which relates to the project or function associated therewith.

A VC Code 102 which is system assigned and may comprise four 4 digit alphanumeric input using both upper and lowercase letters. There are 62⁴=14,776,336 possible combinations of this type of code. If more codes are required a five digit input could be used.

A number of defined Task fields 104 and 106, each of which contain either the name of a Task, OR a link to another VC Mat which must be completed before the current VC can be completed. There may be a simple description or other appropriate identifier. If the task is linked to another VC Mat, then the other VC Mat essentially defines a sub-task. In the Virtual Management System this is referred to as a preceding VC as completion of the preceding VC is necessary before the current VC can be completed. The field will therefore either contain a string of alphanumeric text (in which case it is recognised by the system as a task) or a four digit alphanumeric code which matches an existing VC (in which case it is recognised by the system as a preceding VC).

It should be noted that within a conventional project management system different link types may be possible. Sometimes, one task cannot be started until a sub-task is complete. Another possible link is where a task cannot be completed until a sub-task is complete, which means that it might be possible for the task to be started before the sub-task is complete. Within the virtual management system, only one link type is currently defined; where a sub VC must be completed at some point before a VC can be completed. Each task field also has a logical field associated with it, called “Shared Mat?” 108. If no entry is made, a new Mat is created whenever needed; if an entry is made, this shows that one particular Mat will be used as a preceding VC for several different Mats and therefore the user will need to designate an existing Mat as the preceding VC by entering in the unique Mat code for that particular Mat into the relevant field.

The Mat database object 11 contains as a minimum the following fields or objects: A VC Code 110 which identifies this as the second part of a particular VC. The Struc and Mat VC codes are the same for a particular VC. This allows a unique link between the Struc database object and the Mat database objects for a particular VC Type. Each VC has one Struc database object but may have an unlimited number of Mat database objects.

A Mat Name 112 is user defined and shows what this particular Mat is used for.

A Mat Code 114 is system defined and may comprise a four digit alphanumeric code which identifies this particular Mat object. This code allows links to be created to one or more other Mat objects.

For each task 116, the text defined in Struc will be shown in the relevant task field. Where a new preceding VC is designated then a new preceding Mat will be created and the Mat code for this will be stored in the task field. If a shared Mat has been designated then the VC name will be shown in this field with a reminder that the user must replace this with the relevant Mat code for the shared Mat.

The status of each task or preceding VC in Struc 118 is shown and can typically include the following:—
a) Not started (default value)
b) Started (user modified if a Task; system modified if a link to a preceding VC)
c) Completed (user modified if a Task; system modified if a link to a preceding VC)
d) Not Applicable/Not Used (user modified)

A note 120 may also be included that the user can enter against each task that relates to that specific Mat only.

The Struc and Mat tables 10 and 11 both contain the system assigned VC code and a one-to-many relationship exists between these two fields in the Struc and Mat tables. While there is only one Struc table per VC, there can be one or many Mat tables. Each Mat table has a unique system assigned Mat code.

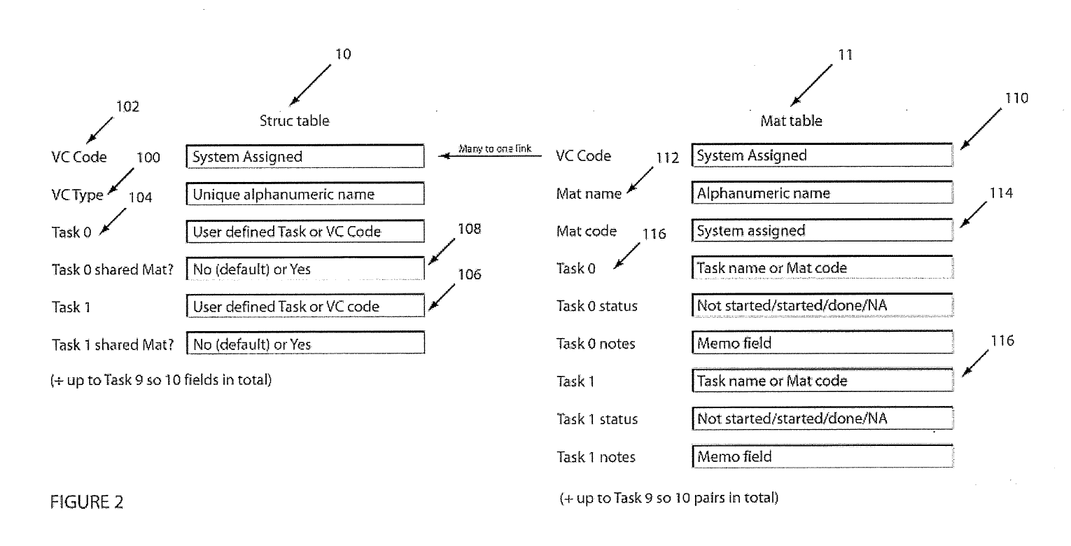

FIG. 2 shows an example of what the VC “Frame a picture” might look like. The cell code 200 and the cell type 202 are identified. In this example there are six tasks in Struc, Task 0 to Task 5 (204, 206, 208, 210, 212 and 214). It could be possible to change a task to a preceding VC in which case Task 1 to “Get correct frame assembly” could then become a VC which guides the process of creating a frame from wood in stock rather than taking one off the shelf. In this way, the Virtual Management System would start off in a very simple manner (with only one VC). Over time it could become more refined and able to guide and track a more sophisticated approach to framing a picture.

Tasks 0-5 in this example are intended to be carried out in a sequential manner. In other words, task 0 is followed by task 1, task 1 by task 2 and so on. However this may not necessarily be true for other VCs. As the process develops a user may determine that an additional task may be necessary, this can be easily incorporated into Struc by means of either adding a task or defining a preceding Mat. Any changes in the new Struc from previous Strucs will be fed back to those previous Strucs and the matching Mats will be updated to show the new task or preceeding Mat. FIG. 2 also shows the Mat table with a many to one link where appropriate with the Struc. The Mat table includes the cell code 216 which is the same as that of the Struc and the Mat name 218 for the particular task, for example a “photo for a fashion show”. The Mat table also includes a Mat code 220 and tasks 0-5 which are identical to the tasks in the Struc. The Mat table includes information relating to the status and notes for each of the tasks, for task 0 these are shown at 222 and 224. The statuses available are the same as those described with reference to FIG. 1. The notes provide additional information, for example colour, type or whatever.

Other Fields can be optionally added to both Struc and Mat to make them more useful for a Virtual Management System. These include the following Struc fields: A fixed link to references or resources relevant to completing the VC which have a fixed URL or other type of link. As an example, this could be a Mathcad worksheet, a page in the system giving reference information, online training on the subject or an external web page which has a URL that won't change. A further field is a dynamic link to references or resources which require a lookup table to determine the actual URL or other type of link. These dynamic references can be classified as either regulatory or policy.

A Regulatory link will determine the jurisdiction of the project, for example from a Project master database and will then provide a link to a web page or document containing the applicable regulations, which must be followed. These may be selected from a list of links in a lookup table. This means that the lookup table must be completed before a particular regulatory link is available within the Virtual Management System.

A Policy link will determine the particular client from the Project master database and will then provide a link to a Web page or document containing the relevant client policy which should ideally be followed, but may be dispensed with where justification exists. This is selected from a list of links in a lookup table. If no record exists for the particular jurisdiction or client, then the lookup table points to a web page which states that no record exists. This can then be update by the user if necessary.

Another additional optional field is a Struc blog in which the system adds entries when Struc modifications are made showing the time, date, what caused the modification, and also to allow the modifier to add any relevant comments.

The Struc Guardian is another additional optional field in which the person responsible for the VC is indicated. Generally this person will indicate approval (or not) of proposed changes to the VC, bearing in mind the effect of a proposed change will have an impact throughout the system.

A persistent note may also be provided in the VC which is applicable to all VCs of this type, as opposed to notes on an individual Mat. A user can therefore make notes on lessons learned to help others using the same type of VC. Ideally this would not normally require any admin privileges.

Additional Mat fields may include a number of different optional Mat fields.

A name field called “User” may provide a link to the record of a person on the database, that person being currently responsible for completing a particular VC. Similarly, a name field called “Supervisor” may provide a link to the record of the supervisor of the person responsible for completing the VC.

A further additional optional field is the Mat blog which keeps a basic record of the work done for a task in a blog. The supervisor can also add to the blog. Reading the blog could also allow auditing of how, when and where the task was carried out. Also, details such as a change of user or supervisor would be recorded in the blog. Blog entries once created cannot be edited and the time and date are recorded.

Another additional optional Mat field is the task completed signature. The supervisor of the responsible user for a Mat uses this field to digitally sign that the Mat is complete. This contains a link to the record of the supervisor signing off the Mat and a time/date stamp. The Mat can only be signed off if all tasks and preceding Mats are shown as being complete.

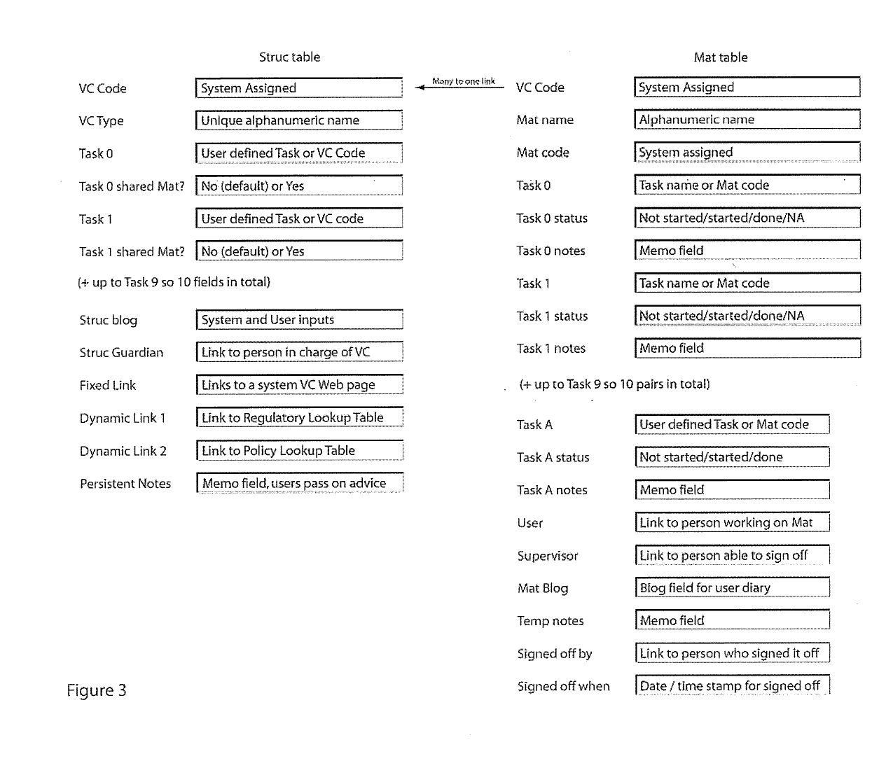

FIG. 3 shows a VC structure suggested for a Virtual Management System which could be used to manage tasks in the oil industry. Typical tasks could be to design and program a single well and then expand this to a full field development involving many wells, platforms, production facilities etc. This will now be described in more detail.

The first objective is to build a Virtual Management System for the project in question. A project is created by defining a set of data in database objects. The project information could include many different parameters. An example is the legal jurisdiction (usually a state or country) which defines the legal regime under which the project may operate. Another example is the client (i.e. the entity paying for the Virtual Management System and the operator of the project).

Each project has a name and a system assigned unique 4 digit identification code. In the example the first project is called “Vitol Offshore Ghana”. The client has a record on the database for the office responsible for the project, along with a main contact. Each person working on the project who must interface in any way with the Virtual Management System also has a record on the database. This record defines the privileges of the user when logged in to the Virtual Management System.

At least two lookup tables are created which are database objects, for example one relates to regulatory matters and the other to policy issues.

Within the regulatory field there is information relating to each country in the form of a list of titles (e.g. “Well Abandonment”) and a URL for each title. The URL can point to either a web page containing information and further links, or it can point direct to the regulatory requirements for the relevant information for that country.

Within the policy field for each first client there is a list of titles (e.g. “Casing Design Factors”) and a URL for each title. The URL points to a system web page containing information and further links. If the client has no policy but the Project Management Contractor (PMC) does, then the URL can point to a web page explaining that in the absence of a client policy the PMC policy will apply. If both the client and PMC have policies, links to both can be given but showing that in the event of a conflict which policy would apply.

This web page could also contain information on how dispensation can be requested.

Once the Project for Vitol Offshore Ghana has thus been defined, an oilfield can be created within the Project. Once an oilfield is defined, the first VC is created within it. In order to keep the interface simple and instinctive, a graphical view of the Project could show the high level VCs to the left with sub level VCs to the right. It is not necessary to create an oilfield until it is required or the details of the project are clear. User 1 (a Drilling Engineer) creates a field for a well design which creates a design for a well but might not include instructions for implementing that design. The first VC is therefore created from the blank VC template of FIG. 3 and is given the type “Well Design, Floating Rig”. The system then assigns a unique 4 digit code to this VC Type. Within the VC four Tasks are defined within the Struc. These are: Completion Design; Casing Design; Wellhead Design; and Wellbore Fluids Design. These Tasks are stored within Struc because they are the same for every instance of the Well Design, Floating Rig VC type. By default the status of each of these within Mat is entered as “Not Started”. As the tasks are not 4 digit codes, the database recognises them as text strings and treats them accordingly and at this stage it makes no difference whether the field “Shared Mat?” is left at the default No or changed to Yes. A fixed link is created to a template used to create a basis of well design document. Dynamic links may also be defined as the user is the VC creator. These dynamic links point to the lookup tables previously mentioned. Accordingly, as a starting point, for the first VC, the lookup tables would be completed for any relevant regulations or policies relating to the tasks created in this first VC. Once the data held within Struc is defined, then the data held within the first Mat can be entered.

The identity of the user is entered by the user and stored within Mat as this is specific to this particular VC and indicates who is responsible for completing this particular VC. By default, the creator of this VC is shown as the Supervisor. (Note that the Supervisor and User can change during the life of the VC). The Project is selected from a list of those on the Virtual Management System (which in this example is “Vitol Offshore Ghana”) and the VC is given a name, for example, “Sankofa A” which is the name of the well to be designed.

The system assigns a unique 4 digit Mat code to this Mat. The matching Struc is identifiable by the Virtual Management System as both Struc and Mat share a common VC Code. Within the Virtual Management System, the path to this Mat is defined as xxxx:yyyy where xxxx is the 4 digit Project Code and yyyy is the 4 digit Mat Code. This path also shows the dependencies of the different elements for example where an element to the right, must be completed before one to the left of it can be completed.

The first VC in the Virtual Management System could not define any preceding VCs at the time of its creation because it was the first. Now a second VC can be created and associated to the first VC. This happens within Struc.

A second VC with the VC type “Casing Design” is defined. This VC has five tasks; “Preliminary Design”, “Load Case 1”, “Load Case 2”, “Load Case 3” and “Connection Selection”. Returning now to the VC for “Well Design, Floating Rig”, there is a task called “Casing Design” within Struc. This task is now converted to a link to a preceding VC by entering in the VC Code for “Well Design, Floating Rig” into the field for the second VC and the Casing Design VC is now designated as this preceding VC. The “Shared Mat?” field is left at the default No. Throughout the Virtual Management System, a new Casing Design Mat with default values is created, one for each Mat of type “Well Design, Floating Rig”. Each existing Mat of type “Well Design, Floating Rig” now has a preceding Mat of type Casing Design.

All tasks and preceding VCs must be completed before a VC can be signed off by the supervisor as complete. The VC for Well Design, Floating Rig now contains three Tasks (completion design, wellhead design, wellbore fluids design) and one preceding VC (casing design).

The path to this second VC within the Virtual Management System could be shown by a series of four digit codes, like xxxx:yyyy:zzzz. By replacing one of the tasks within the Well Design VC by another VC, the Virtual Management System has become more refined. Each time a new VC is created, tasks and/or preceding VCs are defined within the Virtual Management System.

The VC Structure Replication will now be described. A second user (an engineer) is working on the Vitol Offshore Ghana project and needs to start work on a second well, which will be called Sankofa B. The Virtual Management System graphical interface for the Vitol Offshore Ghana project is opened and within this project the VC for “Well Design, Floating Rig” which is named Sankofa A are available. The VC Code for the VC “Well Design, Floating Rig” opens the Project file and is entered as the VC Code into the relevant field in the project; this now becomes a preceding VC for the project in question.

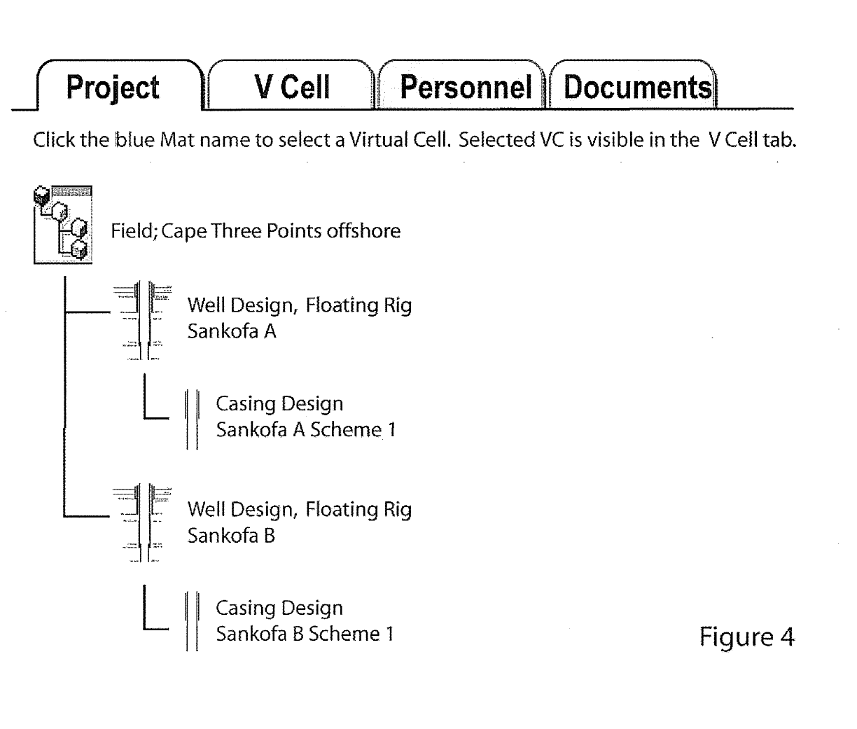

The database now creates a new Mat of type “Well Design, Floating Rig” within the project and also recreates the entire structure of this VC and all preceding VCs necessary to complete this VC. Each new Mat receives a new, unique 4 digit Mat code. The highest level Mat, the Well Design, Floating Rig Mat, is given a new name by user 2. As user 2 works through each Mat, the Mat fields have the system defaults placed in them which can be altered as necessary. The Struc fields visible for each Mat show the Struc level data, such as fixed and dynamic links, persistent notes, the names of each task and links to each preceding Task. FIG. 4 shows how the web Virtual Management System page for the Vitol Offshore Ghana project might look at this stage.

Working on the Well Design VC user 2 realizes that the VC can be improved. One element of Well Design is missing and that is to define the directional path of the well. User 2 has sufficient privileges to modify Struc, and can thus add a task to the Well Design, Floating Rig VC for Sankofa B which is called “Directional Design”. This updates all VCs of type Well Design, Floating Rig. User 1 can therefore see this additional task in the Virtual Management System task for Sankofa A. If the VC for User 1 has not been signed off as complete then this new preceding VC will need to be completed (a copy of any associated Mat will be replicated in the Sankofa A structure as well) before the Well Design, Floating Rig VC can be completed.

If a change is made to a VC Struc, then that change is reflected in all other VCs of that Type. This is beneficial but must be carefully managed as the “Law of Unintended Consequences” may apply. Before any change is made all users who have unfinished VCs of that type should be notified of the proposed change and allowed to comment on the change before it is implemented. Also other checks may be built into the system requiring different levels of approval for changes to the fields. If a Struc Guardian is identified, only that user can make a change to the Struc. In addition, when a change is made, it will not affect a completed and signed off VC in a way which tags it as no longer being completed. If a Struc is modified to add a preceding VC, that preceding VC must already exist and a link to it can be established as one of the tasks. All modified VCs will then show that link and a new Mat will be created for each VC which lists it as a preceding VC.

Assuming User 2 identifies a further improvement to the Virtual Management System: when designing a casing for a well, the subsurface temperature profile (how the temperature changes with depth) must be known to complete the design calculations. However this information will be the same for all the wells in a given oil field and so only one VC to ascertain the temperature profile is needed for any number of wells in that oil field.

There is actually a choice of two actions for accomplishing this. The Casing Design Struc table could be modified to add a task “Ascertain temperature profile”. This would add a task of that name to each Casing Design Mat. Alternatively a new VC called “Field Temperature profile” can be created and the VC Code for that can be entered into the Casing Design Struc table (Task 5) and set the “Shared Mat?” task 5 field is set to Yes. This would cause the Casing Design Mat to display at task 5 the message “Replace this with Mat code for “Temperature profile”. A new Temperature Profile Mat could then be created and set as a preceding task within the Project (or Field) table, which can be modified as needed with notes etc. Then the Mat Code for that Mat it is entered into the Casing Design task 5 field. This would have to also be carried out for the casing design Mat for Sankofa A well in task 5.

A particular Mat may require a preceding Mat that does not create preceding Mats for every instance of a VC. This can be done by creating a new Mat (from an existing VC, or creating a new one as necessary) then entering the Mat code into an empty task field within the parent Mat.

What is claimed is:

1. A virtual management system for completing a project, wherein the project includes a function having one or more tasks associated therewith, the system comprising:
a database object (VC) for the function, wherein the database object includes a pair of database object parts (Struc and Mat);
wherein a first part of the pair of database object parts relate to a structure for the or each task and a second part of the pair of database object parts relate to a content element for the or each task;
and wherein the first part undergoes an evolution in response to user input to enable improvements to be implemented for a particular function, such that the evolution applies to the particular function in any project managed by the virtual management system;
and further wherein the second part can be replicated for a subsequent function to generate a subsequent database object for the subsequent function.

2. The system of claim 1, wherein the database objects are linked in a hierarchical manner to define an order in which the functions must be completed to complete the project.

3. The system of claim 1, wherein the first and second parts each include a plurality of database fields.

4. The system of claim 3, wherein at least some of the database fields relate to the or each task required for the relevant function.

5. The system of claim 3, wherein the database fields in the second part include a hierarchical set of tasks required to complete the function.

6. The system of claim 1, wherein there are multiple second parts for each first part.

7. The system of claim 1, where the evolution includes changes in the first part, such that all first parts of the same type for any project are updated by the evolution.

8. A method of forming a virtual management system for completing a project, wherein the project includes a function having one or more tasks associated therewith, the system comprising:
forming a database object (VC) in a database for the function, wherein the database object includes a pair of database object parts (Struc and Mat);
storing data relating to the structure of the function for the or each task in a first part of the pair of database object parts and storing data relating to the content of the or each task in a second part of the pair of database object parts;
evolving the first part in response to user input to enable improvements to be implemented for a particular function, such that the evolution applies to the particular function in any project managed by the virtual management system;
replicating the second part for a subsequent function to generate a subsequent database object for the subsequent function.

9. The method of claim 8, further comprising linking the database objects in a hierarchical manner to define an order in which the functions must be completed to complete the project.

10. The method of claim 8, further comprising providing the first and second parts with a plurality of database fields.

11. The method of claim 10, further comprising entering at least some database fields that relate to the or each task required for the relevant function.

12. The method of claim 10, further comprising linking the database fields in the second part into a hierarchical set of tasks required to complete the function.

13. The method of claim 8, further comprising linking multiple second parts for each first part.

14. The method of claim 8, where the step of evolving comprises changing the first part, such that all first parts of the same type for any project are changed.

15. A computer program comprising instructions for carrying out a method of forming a virtual management system for completing a project, wherein the project includes a function having one or more tasks associated therewith, the system comprising:
forming a database object (VC) in a database for the function, wherein the database object includes a pair of database object parts (Struc and Mat);
storing data relating to the structure of the function for the or each task in a first part of the pair of database object parts and storing data relating to the content of the or each task in a second part of the pair of database object parts;
evolving the first part in response to user input to enable improvements to be implemented for a particular function, such that the evolution applies to the particular function in any project managed by the virtual management system;
replicating the second part for a subsequent function to generate a subsequent database object for the subsequent function, when said computer program is executed on a programmable apparatus.
